(19) United States
(12) Patent Application Publication
(10) Pub. No.: US 2012/0104037 A1
(43) Pub. Date: May 3, 2012

(54) SYSTEM AND METHOD FOR STORAGE AND APPLICATION OF CONDIMENTS/SAUCES

(76) Inventor: Eliav Ben-Shoshan, Holon (IL)

(21) Appl. No.: 13/381,710

(22) PCT Filed: Jun. 30, 2010
(86) PCT No.: PCT/IB10/53005

§ 371 Date: Dec. 30, 2011

Related U.S. Application Data
(60) Provisional application No. 61/221,636, filed on Jun. 30, 2009.
(60) Provisional application No. 61/229,008, filed on Jul. 28, 2009.
(60) Provisional application No. 61/258,225, filed on Nov. 5, 2009.

(51) Int. Cl. B67D 7/78

(52) U.S. Cl. 222/1; 222/129

(57) ABSTRACT

Disclosed, is a system and method for storage and application of condiments/sauces comprising a dispenser carousel adapted to allow a user to engage one of two or more storage containers, and a trigger/button adapted to release a certain amount of a condiment/sauce stored in the engaged storage container through a release tap.

### FIELD OF THE INVENTION

The present invention generally relates to the field of substance dispensing and application. More specifically, the present invention relates to a system and method for storage and application of condiments and/or liquid substances.

### BACKGROUND

Condiments, seasonings, spices and sauces are traditionally stored in plastic or glass containers. Such containers are usually stored on kitchen shelves in standard or customized storage cabinets. As most recipes call for different amounts of more than one condiment/sauce type, a typical application of condiments/sauces will usually require several consecutive rounds of: (1) locating a thought after container, (2) withdrawing and opening of the container, (3) measuring the amount of the given condiment/sauce, as instructed by the recipe, (4) closing/sealing/cleaning of the container, and (5) placing the container back at its designated location.

The above described process may repeat itself for each and every appliance of a condiment/sauce, thus creating a repeating non-efficient cycle. Furthermore, condiments/sauces and condiments/sauces based foods are consequently prone to inaccurate measurement, wet or dirty cooks' hands; and unsealed containers that may invite dust, humidity, pests, etc. and/or let condiments'/sauces' aroma escape.

Prior-art solutions such as condiment/sauce containers having punctured or holed seals, have only managed to partially solve some of the above presented problems, while worsening others (e.g. humidity) and creating new ones (e.g. handheld punctured containers are smaller and necessitate more frequent refilling).

Still remains a need in the field of substance dispensing and application, for a method and system for storage and application of condiments/sauces/substances that will enable for the efficient and accurate application of such while keeping them cleanly and safely stored.

### SUMMARY OF THE INVENTION

The present invention is a system and method for storage and application of condiments/sauces. According to some embodiments of the present invention, a system for storage and application of condiments/sauces may comprise of a dispenser carousel adapted to rotate within a dispenser base connected to a dispenser handle.

The dispenser carousel may be adapted to nest and retain two or more condiment/sauce storage containers (e.g. test tube resembling). The bottom of each container, when nested in the carousel, may be shut by a seal/closure and the containers may lean against and be supported by a central support structure. A user may select which of the storage containers to engage, by rotating the storage containers on the dispenser carousel.

The selected storage container may thus be rotated to a certain position (e.g. minimal distance to the dispenser handle) where it is engaged. Pressing a trigger/button on the dispenser handle may cause a transmission arm to open a condiment/sauce release tap on the engaged storage container's seal/closure, allowing a certain amount of the condiment/sauce within the engaged container to be applied. Upon release of the trigger the release tap may return to its closed position.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1D show: an isometric view (1A), a side view (1B), a back view (1C) and a top view (1D); of an exemplary system and method for storage and application of condiments/sauces, in accordance with some embodiments of the present invention;

FIGS. 2A-2D show: an isometric view (2A), a side view (2B), a back view (2C) and a top view (2D); of an exemplary seal/closure, in accordance with some embodiments of the present invention; and

FIGS. 3A-3E show: an isometric view (3A), a side view (3B), a back view (3C), a top view (3D) and a section view (3E); of an exemplary release tap, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and elements have not been described in detail so as not to obscure the present invention.

Unless specifically stated otherwise, as apparent from the following discussions, it is appreciated that throughout the specification discussions utilizing terms such as “applying”, “adding”, “sprinkling”, “seasoning”, “flavoring”, “pouring” or the like, refer to the action and/or processes of a predetermined-extraction of a pre-selected substance, and possibly at a pre-selected amount, enabling system or device, which “releases”, “extracts”; and then “applies”, “adds”, “sprinkles” or the like of condiments, seasonings, spices, powdered drinks, coffee, sugar, sweets, sauces, grooming materials, and/or liquids. Further, the term “condiments/sauces” may relate to any substantially small-particles, powdery, thickly textured or liquid material, such as, but in no way limited to, those used for changing and/or emphasizing the tastes and flavors of foods.

Embodiments of the present invention may include apparatuses for performing the operations herein. Such apparatus may be specially constructed for the desired purposes, or it may comprise of general-purpose components.

The processes and components presented herein are not inherently related to any particular embodiment, various general-purpose devices and systems may be used in accordance with the teachings herein, or it may prove convenient to construct a more specialized apparatus to perform the desired action. The desired structure for a variety of these systems will appear from the description below.

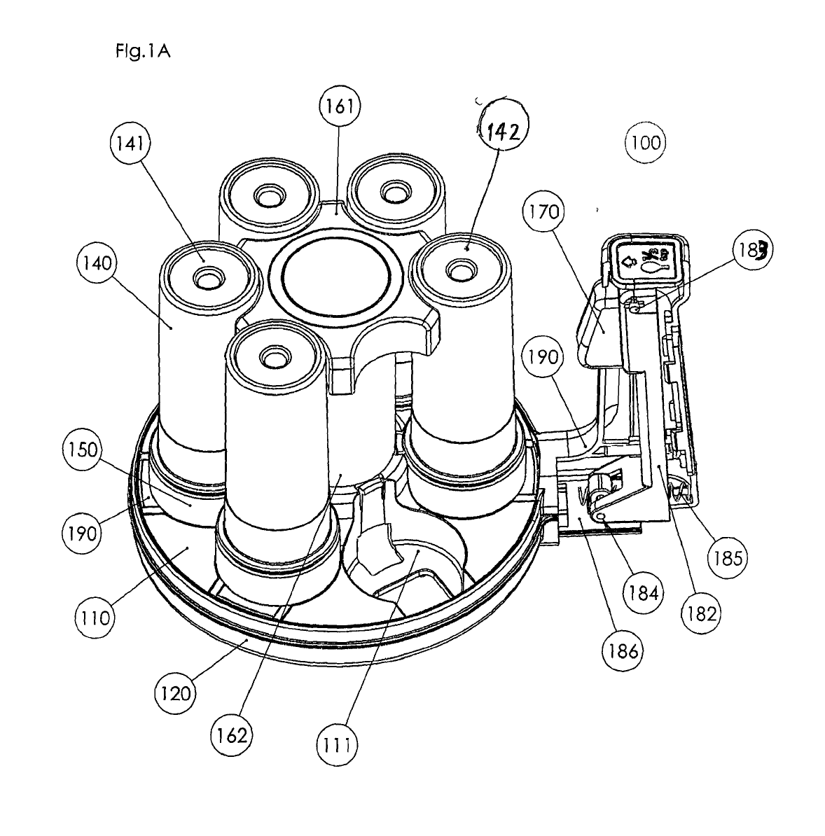

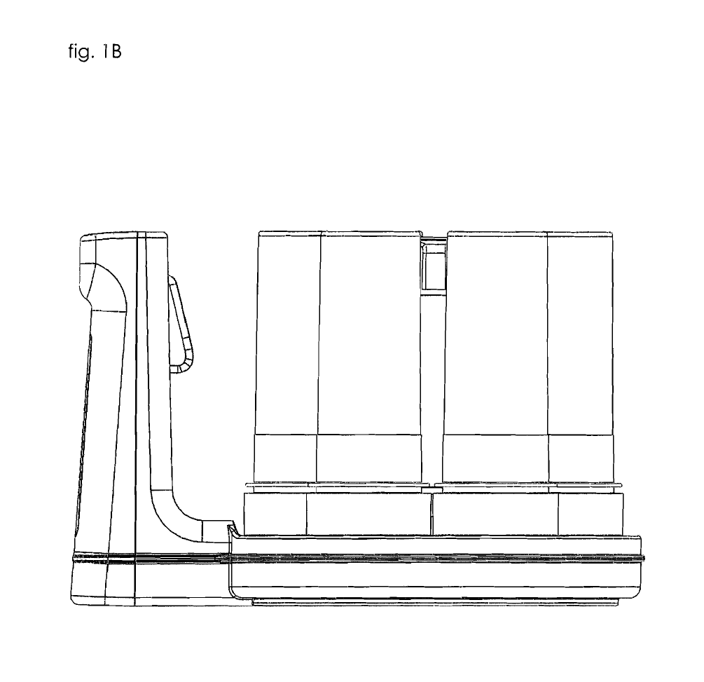

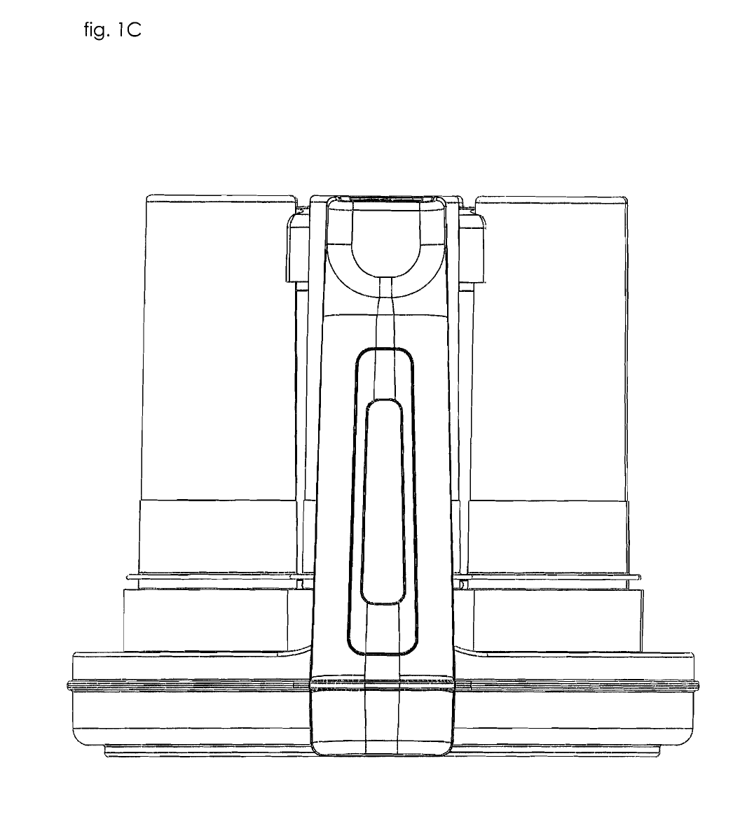

The present invention is a system and method for storage and application of condiments/sauces. Reference is now made to FIGS. 1A-1D where there is shown, in accordance with some embodiments of the present invention, an exemplary system for storage and application of condiments/sauces (100) comprising a dispenser carousel (110) adapted to rotate within a dispenser base (120) connected to a dispenser handle (130).

The dispenser carousel may be adapted to nest and/or retain two or more condiment/sauce storage containers (140) (e.g. test tube resembling) in their container housings (111). The bottom of each container, when nested in the carousel, may be shut by a seal/closure (150) and the containers may lean against and be supported by a central support structure (160). A user may select which of the storage containers to engage, by rotating the storage containers nested in the dispenser carousel (110).

According to some embodiments of the present invention, each storage container (140) may be cylindrical, or differently shaped. The storage containers (140) may be constructed from one or more of a variety of materials (e.g. plastic, metal) and may be transparent. Each storage container's (140) seal/closure (150) may be screwed or otherwise locked into position in which the container is substantially sealed. The seal/closure (150) may be opened, and the opening created, used for filing the storage facility with a selected condiment.

According to some embodiments of the present invention, storage containers (140) may be individually withdrawn from the dispenser carousel (110). Once withdrawn a given container's seal/closure (150) may be removed (e.g. unscrewed) and the container may be refilled, reclosed and returned to its respective, or to any other vacant, container housings (111) on the dispenser carousel (110). Alternatively, the removed container may be substituted with a new and/or prefilled container. Various, new and full, storage containers may be sold separately, or containers may be manually or automatically filled at a storage facility or from other containers. According to further embodiments, the seal/closure (150) may be adapted to close a certain manufacturer's/distributer's containers, for example, by having screwing tracks compatible with the screwing tracks of the manufacturer's/distributer's regularly sold containers.

According to some embodiments of the present invention, storage containers (140) may be identified (i.e. as corresponding to a given condiment/sauce/substance) by their shape, color, label or other differentiating characteristic. According to some embodiments, identifying tags (141) or decals may be attached to (e.g. the top of) one or more of the containers. Tags may be of different colors and/or shapes, and/or may be labeled with a writing or picture identifying the substance in their respective container. Identifying tags (141) may also be sold separately or may be pre-attached to certain manufacturers'/distributers' separately sold containers.

According to some embodiments of the present invention, the bottom of the central support structure (160) may be connected to the dispenser carousel (110) and may rotate along with it, while its shape may offer support to the storage containers (140) (e.g. substantially at their top section). According to some embodiments, the central support structure (160) may further comprise arms/clamps (161), or another form of mechanism, adapted to retain the storage containers' (140) bodies (e.g. substantially at their top section) and prevent them from moving and/or being unintentionally released.

According to further embodiments, the central support structure (160) may comprise locking mechanisms (162) (e.g. ledges) wherein each of the locking mechanisms (162) is adapted to click over/into an edge/space, between a storage container (140) and its closed seal/closure (150), once the container is inserted into that locking mechanism's (162) respective container housings (111). Alternatively, a specially designed edge/space may be made on the storage containers' (140) body and/or on its seal/closure (150).

According to some embodiments of the present invention, a user selected storage container (140) may be rotated to a certain position (e.g. minimal distance to the dispenser handle) where it is engaged. According to some embodiments, while rotating the dispenser carousel (110) it may click into position whenever one of the storage containers (140) has reached a position where it is engaged.

According to some embodiments of the present invention, pressing a trigger (170) on the dispenser handle (130) may cause a transmission arm (180) to open a condiment/sauce release tap (190) on the concurrently engaged storage container's (142) seal/closure (150), allowing a certain amount of the condiment/sauce within the engaged container to be applied. Upon release of the trigger the release tap (190) may return to its closed position.

According to some embodiments of the present invention, the transmission arm (180) may comprise of a vertical transmission arm (181) and a horizontal transmission arm (182). Once pressed, the trigger (170), which may be connected to or integrated into the vertical transmission arm (181), may cause the vertical transmission arm (181) to move backwards, inside the dispenser handle (130), and, in a direction away from the central support structure (160). According to some embodiments, the vertical transmission arm (181) may be connected to the dispenser handle's (130) interior, substantially at its top section, by a vertical transmission arm axle (183), a flexible material, and/or any other means that may retain the vertical transmission arm's (181) upper edge or section, while allowing the rest of the arm to travel when the trigger (170) is pressed.

According to some embodiments of the present invention, the vertical transmission arm (181) may be connected at its lower edge or section, by a vertical to horizontal transmission arm axle (184) to the horizontal transmission arm (182). The horizontal transmission arm (182) may extend from the axle to substantially the center of the dispenser carousel (110), optionally passing between dispenser carousel (110) and the dispenser base (120). The horizontal transmission arm (182) may comprise a tap engaging ledge (186), optionally at its edge or section furthest away from the axle, adapted to cause the condiment/sauce release tap (190) of the concurrently engaged storage container (140) to open, as the ledge moves along with the horizontal transmission arm (182) in a direction away from the center of the dispenser carousel (110) and towards the base of the dispenser handle (130).

According to some embodiments of the present invention, a vertical transmission arm retracting mechanism (185), for example—a spring positioned between the vertical arm and back side of the handle, may be adapted to return the transmission arms and the trigger back to their original positions once the trigger (170) is released.

Various other methods and/or mechanisms (e.g. wire based mechanisms) may be practiced, along with the abovementioned teachings and techniques, in order to transmit the movement from the trigger (170) to the tap engaging ledge (186), these all fall within the true spirit of the present invention, and have not been described as not to obscure the present invention.

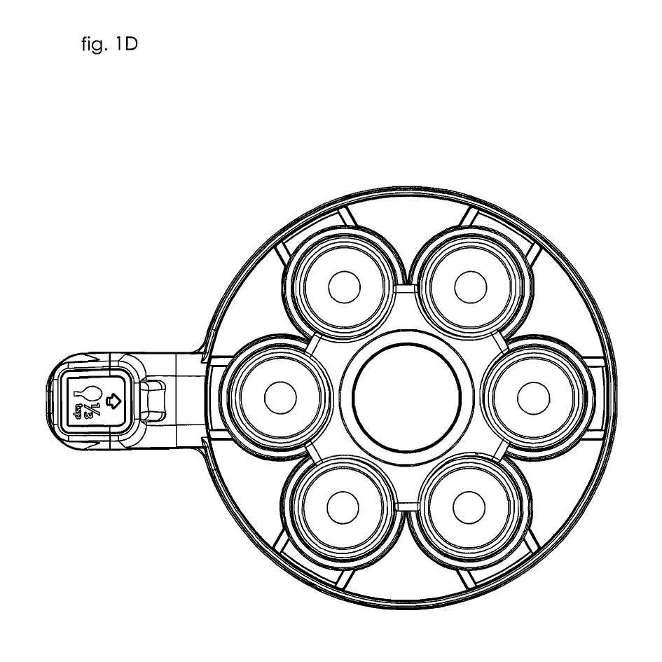

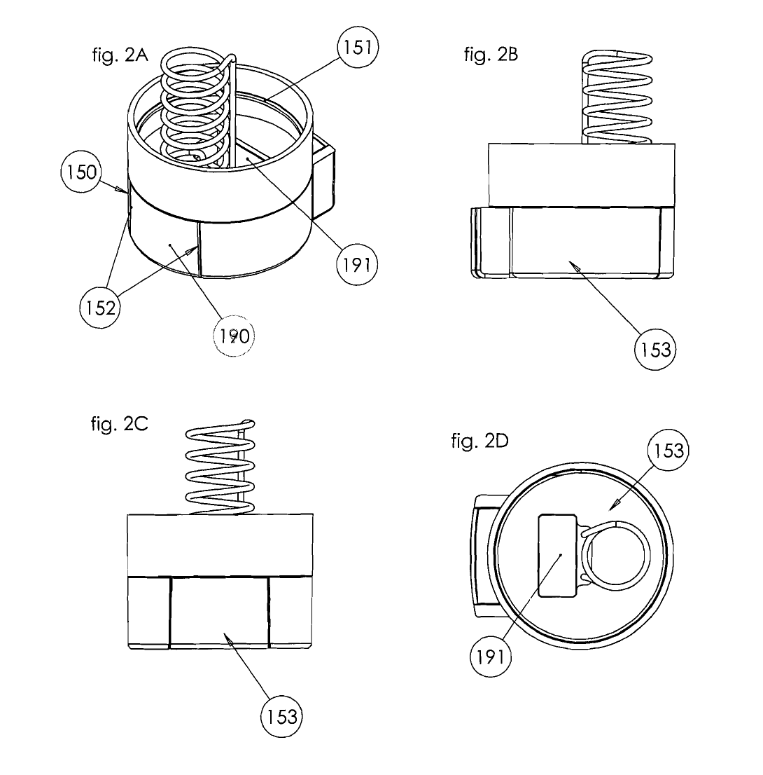

Reference is now made to FIGS. 2A-2D where there is shown, in accordance with some embodiments of the present invention, an exemplary storage container (140) seal/closure (150). The seal/closure (150) may comprise, substantially at its upper section, screwing tracks (151) or other connection means for connecting to and closing one of the storage containers (140). Substantially at its bottom section, the seal/closure (150) may comprise a cross section gap/space (152) adapted to allow the condiment/sauce release tap (190) to move/slide inside it along the open cross section. According to some embodiments, a cross gap/space bridge (153) may be adapted to act as a track for the release tap (190) while limiting its range of movement.

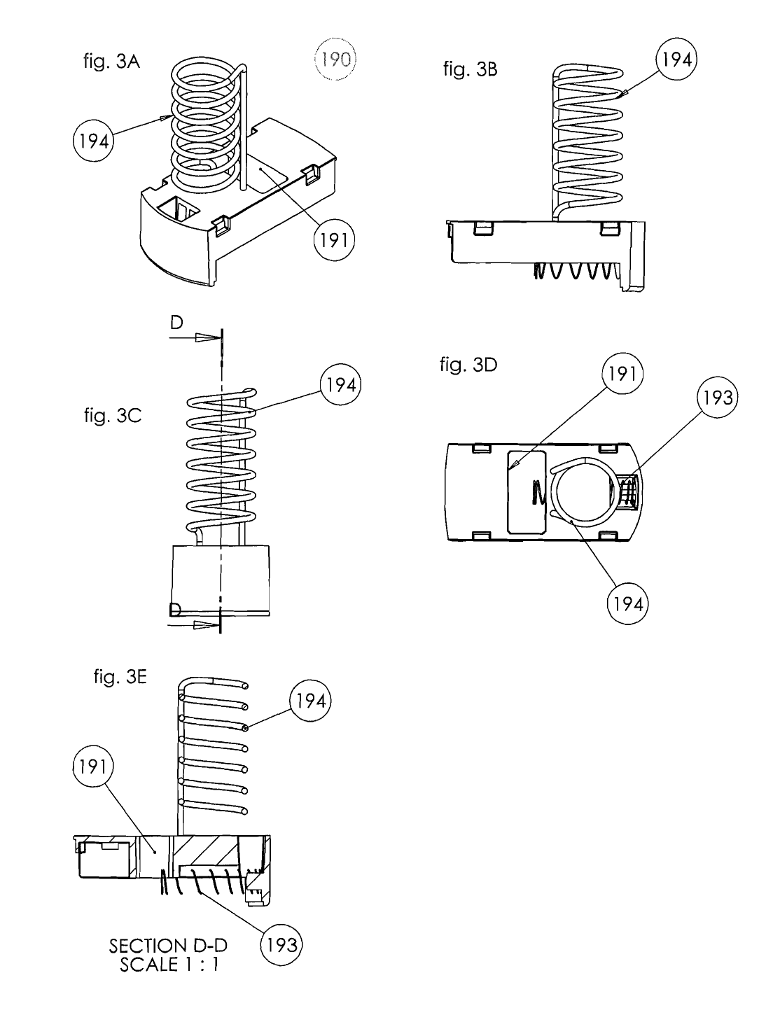

Reference is now made to FIGS. 3A-3E where there is shown, in accordance with some embodiments of the present invention, an exemplary seal/closure (150) release tap (190). The release tap (190) may comprise a condiment/sauce reservoir (191)—open block/area that may allow for a certain amount of condiment/sauce to travel into it. According to some embodiments, the cross gap/space bridge (153) may seal the bottom of the reservoir and prevent the condiment/sauce from escaping when the tap is in its closed position; according to other embodiments, a customized tap reservoir seal ledge/surface may be adapted to seal the reservoir. The tap engaging ledge (186), when actuated by the trigger, may hook and push onto the condiment/sauce release tap (190) and cause it to move/slide inside the cross section gap/space (152) to a position in which the bottom of the condiment/sauce reservoir (191) is no longer sealed by the cross gap/space bridge (153); thus allowing the condiment/sauce amount sealed in the reservoir to be released and applied.

According to some embodiments of the present invention, a release tap retracting mechanism (193) (e.g. a spring) may be adapted to return the condiment/sauce release tap (190) to its initial closed position upon a manual release of the trigger (170) or an automatic release of the trigger's movement transmission.

According to some embodiments of the present invention, a condiment/sauce mixing device (194) (e.g. spring, bent metal wire) may be adapted to mix, stir and/or move condiments/sauces inside the storage container (140) to which its seal/closure (150) is connected, thus preventing the accumulation of condiments/sauces along the inner sides of the container's walls and/or facilitating their travel into the condiment/sauce reservoir (191). The condiment/sauce mixing device (194) may be connected at or around the top of the condiment/sauce reservoir (191) and may thus be adapted to move and travel along with the release tap (190), which movement may create its mixing, stirring and/or moving effect.

According to further embodiments of the present invention, a given period of time for which the condiment/sauce release tap (190) is held and/or kept in its open position, or the number of times it is engaged, may correspond to a certain amount of condiment/sauce falling/flowing through the tap. Accordingly, an exemplary two second hold down of the tap may, for example, correspond to two pinches of salt, 2 milliliters of vinegar and/or two teaspoons of sugar.

Various additional mechanical, electronic and/or computerized sealing and taping systems, devices and features may be used, along with the abovementioned teachings and techniques, in order to control the substance application and/or its speed/frequency/amount, and/or other flowing parameters of the substance; these all fall within the true spirit of the present invention, and have not been described as not to obscure the present invention.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for storage and application of condiments/sauces comprising:
a dispenser carousel adapted to support two or more storage containers in a revolve able means such that one of the two or more containers is positioned over a dispenser opening; and
a dispensing trigger to release a predefined amount of a condiment/sauce stored in the storage container positioned over the dispenser opening.

2. The system according to claim 1 further comprising two or more seals/closures adapted to seal the two or more storage containers.

3. The system according to claim 2 further comprising a transmission arm adapted to transmit the movement of the trigger/button to a release tap on the engaged storage container's seal/closure and cause it to open.

4. The system according to claim 3 wherein the release tap further comprises a condiment/sauce reservoir adapted to allow for a certain amount of condiment/sauce from its respective storage container to travel into it.

5. The system according to claim 4 wherein the release tap is further adapted to release the certain amount of condiment/sauce that traveled into the condiment/sauce reservoir as it is moved by the transmission arm.

6. The system according to claim 4 wherein the release tap further comprises a condiment/sauce mixing device adapted to mix, stir and/or move condiments/sauces inside the storage container to which its respective seal/closure is connected.

7. The system according to claim 1 further comprising a support structure adapted to retain each of the two or more storage containers in a respective container housings.

8. A method for storage and application of condiments/sauces comprising:
Revolving a dispenser carousel adapted to support two or more storage containers such that one of the two or more containers is positioned over a dispenser opening; and
Pressing a dispenser trigger to release a predefined amount of a condiment/sauce stored in the storage container positioned over the dispenser opening.

9. The method according to claim 8 further comprising opening a release tap by transmitting the movement of the dispenser trigger to a release tap on the engaged storage container's seal/closure through a transmission arm.

10. The method according to claim 9 further comprising releasing the dispenser trigger, causing the release tap on the seal/closure of the container positioned over the dispenser opening to return to its closed position.

11. The method according to claim 10 further comprising filling up a condiment/sauce reservoir in the release tap with a predefined amount of condiment/sauce by release of the dispenser trigger.

12. The method according to claim 9 wherein opening further comprises causing a condiment/sauce mixing device connected to the release tap to move with it and stir condiments/sauces inside the storage container positioned over the dispenser opening.

13. A system for storage and application of condiments/sauces comprising:
a dispenser carousel adapted to allow a user to engage one of two or more storage containers; and
a trigger/button adapted to release a certain amount of a condiment/sauce stored in the engaged storage container.
